(19) United States
(12) Patent Application Publication
(10) Pub. No.: US 2026/0172939 A1
(43) Pub. Date: Jun. 18, 2026

(54) Out-of-Coverage (OOC) Report for User Equipments Changing Access Mode

(71) Applicant: Telefonaktiebolaget LM Ericsson (publ), Stockholm (SE)

(72) Inventors: Tahmineh Torabian Esfahani, Sollentuna (SE); Ali Parichehrehteroujeni, Linköping (SE); Peter Hedman, Helsingborg (SE); Gautham Nayak Seetanadi, Stockholm (SE); Angelo Centonza, Granada Granada (ES)

(21) Appl. No.: 19/126,070

(22) PCT Filed: Nov. 1, 2023
(86) PCT No.: PCT/SE2023/051100

§ 371 Date: Apr. 30, 2025

Related U.S. Application Data
(60) Provisional application No. 63/421,673, filed on Nov. 2, 2022.

(51) Int. Cl. H04W 36/32; H04W 36/00; H04W 36/14

(52) U.S. Cl. CPC H04W 36/32; H04W 36/0058; H04W 36/14

(57) ABSTRACT

Methods, apparatuses and systems for reporting information relating to out-of-coverage, OoC, situations related to changes in access mode An example method performed by a user equipment, UE, comprises receiving (310) an instruction or detecting a trigger to change the UE's access mode, where the change in the UE's access mode includes a change in one or more radio resources available to the UE for accessing a network. The method further comprises determining (320) that the UE has experienced an OoC situation with respect to the change in the UE's access mode and logging (330), for subsequent reporting, an indication of the OoC situation and/or information and/or measurements pertaining to the OoC situation.

### TECHNICAL FIELD

The present disclosure is generally related to wireless networks and is more particularly related to techniques for logging information relating to out-of-coverage conditions when changing access modes.

### BACKGROUND

The 3GPP specifications for 5G systems (5GS) provide support for Non-Public Networks (NPNs), which are 5GS deployed for non-public use. An NPN is either:
a Stand-alone Non-Public Network (SNPN), i.e., operated by an NPN operator and not relying on network functions provided by a Public Land Mobile Network (PLMN), or
a Public Network Integrated NPN (PNI-NPN), i.e., a non-public network deployed with the support of a PLMN.

An NPN and a PLMN can share NG-RAN as described in clause 5.18 in 3GPP TS 23.501 [1].

### Stand-Alone Non-Public Networks

The combination of a PLMN ID and Network identifier (NID) identifies an SNPN. NIDs are:
either chosen individually by SNPNs at deployment time (and may therefore not be unique) but use a different numbering space than the coordinated assignment
or chosen in a coordinated manner and are therefore globally unique independent of the PLMN ID used; or are globally unique only in combination with the PLMN ID

NG-RAN nodes that provide access to SNPNs broadcast the following information:
one or multiple PLMN IDs;
a list of NIDs, per PLMN ID, identifying the non-public networks the NG-RAN provides access to;
Optionally:
   A human-readable network name per SNPN;
   Information to prevent UEs not supporting SNPNs from accessing the cell, e.g., if the cell only provides access to non-public networks;

An SNPN-enabled UE supports the SNPN access mode. When the UE is set to operate in SNPN access mode, the UE only selects and registers with SNPNs over the Uu interface. UEs operating in SNPN access mode only select cells and networks broadcasting both PLMN ID and NID of the selected SNPN.

If the UE moves its 3GPP access between SNPN and PLMN, network selection is performed, and the UE performs initial registration. If the UE moves its 3GPP access between SNPNs, network selection is performed, and then the UE performs initial or mobility registration.

### Public Network Integrated NPN

Public Network Integrated NPNs are NPNs made available via PLMNs. When a PNI-NPN is made available via a PLMN, then the UE must have a subscription for the PLMN in order to access the PNI-NPN.

A Closed Access Group identifies a group of subscribers who are permitted to access one or more CAG cells associated to the CAG. CAG is used by PNI-NPNs to prevent UE(s) that are not allowed to access the NPN via the associated cell(s) from automatically selecting and accessing the associated CAG cell(s).

The following is required for identification:
A CAG is identified by a CAG Identifier which is unique within the scope of a PLMN ID;
A CAG cell broadcasts one or multiple CAG Identifiers per PLMN;
A CAG cell may in addition broadcast a human-readable network name per CAG Identifier:

To use CAG, a UE that supports CAG as indicated as part of the UE 5GMM Core Network Capability may be pre-configured or (re) configured with the following CAG information, included in the subscription as part of the Mobility Restrictions:
an Allowed CAG list, i.e., a list of CAG Identifiers the UE is allowed to access; and,
optionally, a CAG-only indication whether the UE is only allowed to access 5GS via CAG cells (see T3GPPS 38.304 [50] for how the UE identifies whether a cell is a CAG cell).

In a given PLMN, the UE shall only consider the CAG information provided for this PLMN.

When the UE is roaming and the Serving PLMN provides CAG information, the UE updates only the CAG information provided for the Serving PLMN while the stored CAG information for other PLMNs is not updated. When the UE is not roaming and the HPLMN provides CAG information, the UE updates the CAG information stored in the UE with the received CAG information for all the PLMNs. The UE stores the latest available CAG information for every PLMN for which it is provided, and keeps it stored when the UE is de-registered or switched off.

The following is assumed for network and cell selection, and access control:
The CAG cell shall broadcast information such that only UEs supporting CAG are accessing the cell (see 3GPP TS 38.300, 3GPP TS 38.304);
The Mobility Restrictions shall be able to restrict the UE's mobility according to the Allowed CAG list (if configured in the subscription) and include an indication whether the UE is only allowed to access 5GS via CAG cells (if configured in the subscription) as described in clause 5.30.3.3 in 23.501 [1];

Emergency Services are supported in CAG cells for UEs supporting CAG, whether normally registered or emergency registered.

### RAN Sharing

RAN sharing supports sharing scenarios involving non-public networks, i.e., an NG-RAN can be shared by any combination of PLMNs, PNI-NPNs (with CAG), and SNPNs (each identified by PLMN ID and NID).

In all NPN sharing scenarios, each Cell Identity is associated with one of the following configuration options:
one or multiple SNPNs;
one or multiple PNI-NPNs (with CAG); or
one or multiple PLMNs only.

The content of cell access related information has to follow the specified RAN sharing restrictions.

In general, a UE is successfully registered on a private network/NPN if (1) the UE has found a suitable NPN cell to camp on and (2) a location request from the UE has been accepted in the registration area of the cell on which the UE is camped. The UE may have access and subscription profiles for several networks/different network types (SNPN, PNI-NPNs and PLMNs) and will perform registration on a private network/NPN, e.g., SNPN if the UE is capable of services that require registration. How network selection is performed depends on whether the UE is in Idle/Inactive mode or in Connected mode.

For Idle/Inactive mode mobility in a PNI-NPN, a PNI-NPN cell is considered suitable if the broadcasted CAG ID is included in the UE's CAG ID information list (as provided to the UE from 5GC) or if it is a public cell and the UE is not configured with the “CAG only” indication. Upon request from the UEs Non-Access Stratum (NAS), the Access Stratum (AS) layer shall scan its supported frequencies and report the available PNI-NPNs (identified by PLMN ID+CAG ID) to NAS, which then selects the network to use.

For Idle/Inactive mode mobility in an SNPN, the cell selection/re-selection shall only occur within that SNPN, i.e., a cell is only considered suitable if the broadcasted SNPN identifier matches the selected SNPN. This is similar to how normal cell selection/re-selection works when the UE has selected a PLMN. Upon request from NAS, the AS layer searches for SNPN cells, and if an SNPN cell is found the SNPN identifier is reported to the NAS layer which does the network selection.

Connected mode mobility for UEs operating in NPN is similar to regular legacy mobility. A gNB receives the allowed networks in the Mobility Restrictions List (MRL) in 3GPP TS 38.413 such that the gNB knows what are allowable as candidate cells. For PNI-NPN, the Allowed PNI-NPN List is provided to the serving RAN node by the 5GC as part of MRL, hence the serving RAN node(s) can restrict the UEs connected-mode mobility according to the UE's allowed PNI-NPNs. In addition, the mobility procedures can be performed between PNI-NPN and the public network. See FIG. 1, which illustrates cross-network mobility between a PNI-NPN and a public network.

For SNPN connected-mode mobility, up to Rel-17, only a single serving SNPN ID is provided within the MRL, as there is no mobility specified between SNPNs or between an SNPN and a PLMN. Consequently, neighbour SNPN cells of different SNPNs or neighbouring cells of a PLMN are not selected as candidate cells for inter-network mobility between if the UE is registered in an SNPN. Re-registration is currently the only option to change between a PLMN and SNPN. This is shown in FIG. 2.

Cross-network mobility in consideration of various frequency deployments for NPN cells is not fully clear. In general, NPN and PN cells can be deployed with different frequency configurations. With Inter-frequency configuration, NPN cells are operating on different frequencies among their neighbour cells. With intra-frequency configuration: A frequency band might be shared between two different networks (e.g., NPN and PN).

A given UE may have access and subscription to several networks or different network types (SNPN, PNI-NPNs and PLMNs). Also, a UE can perform registration on a private network, e.g., SNPN if the UE is capable of services that require specific subscriptions for registration. In general, a UE is successfully registered on a private network e.g., an SNPN, if (1) the UE has found a suitable cell of the SNPN to camp on and (2) a registration from the UE has been accepted in the registration area of the cell on which the UE is camped.

### SUMMARY

One possible scenario when a UE has multiple network subscriptions is that a UE is mandated to change its access mode, e.g., to a mode in which it is accessing a certain private network, e.g., an SNPN, while the UE is out of coverage of the private network. In this use case, the UE is requested to perform registration to the private network that it has a subscription to, but at a time and/or place where the UE cannot find any suitable cell for registration. In other words, the UE may be located in an area for which no sufficient signal level is detected by the UE (UE is detecting coverage hole at its present location for the private network). In some cases, the coverage hole may be intentional-created by a malicious UE(s). In any of these situations, the UE's attempts to attach the network fail, or the UE does not attempt any registration procedure/establishment procedure due to weak signal levels.

According to the current specifications, the network, and in particular those network nodes responsible for system optimization and maintenance, are unaware of when or how often these scenarios occur, because the UE does not report details about access procedure issues like those described above. This is a problem because the UE may experience a situation where no service can be accessed because the UE is instructed to register to a private network but there is no coverage for that private network. There could be, in the meantime, coverage for a different type of network, e.g., a public network.

It has been proposed in 3GPP RAN2 #119bis meeting (R2-2210800) to log certain UE out-of-coverage information in a Minimization of Drive Time (MDT) report. However, logging out-of-coverage information in MDT report may not be possible in every situation, as this requires the UE to have been previously configured with logged MDT measurements. Providing such configuration ahead of time may not be feasible, in particular when UE is suddenly requested to switch access mode to an NPN.

These and other problems described herein are addressed by the various techniques, apparatuses, and systems described herein. These techniques include, for example, a method performed by a UE, where the method includes receiving an instruction or detecting a trigger to change the UE's access mode, where the change in the UE's access mode includes a change in one or more radio resources available to the UE for accessing a network. This example method further includes determining that the UE has experienced an out-of-coverage (OoC) situation with respect to the change in the UE's access mode and logging, for subsequent reporting, an indication of the OoC situation and/or information and/or measurements pertaining to the OoC situation.

Related techniques include an example method performed by a network node. This example method includes receiving, from a UE, a message comprising an indication of an OoC situation encountered by the UE in connection with an attempted change in access mode and/or information and/or measurements pertaining to the OoC situation, where the change in the UE's access mode includes a change in one or more radio resources available to the UE for accessing a network.

Apparatuses corresponding to and configured to carry out the methods summarized above are also described in detail below. For instance, an example UE comprises radio circuitry for communicating with a network and processing circuitry operatively coupled to the radio circuitry, where the processing circuitry is configured to receive an instruction or detecting a trigger to change the UE's access mode, and where the change in the UE's access mode includes a change in one or more radio resources available to the UE for accessing a network. The processing circuitry is further configured to determine that the UE has experienced an OoC situation with respect to the change in the UE's access mode and log, for subsequent reporting, an indication of the OoC situation and/or information and/or measurements pertaining to the OoC situation.

Similarly, an example network node according to some of the embodiments disclosed herein comprises radio circuitry configured to communicate with one or more UEs and processing circuitry operatively coupled to the radio circuitry, where the processing circuitry is configured to receive, from a user equipment, a message comprising an indication of an OoC situation encountered by the user equipment in connection with an attempted change in access mode and/or information and/or measurements pertaining to the OoC situation, wherein the change in the UE's access mode includes a change in one or more radio resources available to the UE for accessing a network.

One of the advantages of the solutions described herein is to enhance SON/MDT reports such as RA report or CEF report or MHI to include OoC related information so that a network operator can optimize the coverage planning, e.g., discovering the coverage holes particularly on the coverage edges or the overlapping area that need to be covered by more than one network, e.g., area with coverage of both PN and NPN. Optimizing the coverage is important to a network to ensure maximum network performance and service availability.

As described herein, logging the out-of-coverage situation in an RA report or a CEF report or in an MHI report, or a new dedicated report (e.g., outOfCoverage-Report-r18) for the out-of-coverage situation, enables UE to “always” log the information pertaining to the out-of-coverage occurred while changing the access mode to the other network, without being constrained to an MDT configuration or a running instance of an MDT measurement.

Another advantage of the solutions is that the OoC information can also be used to promote UE vendors to implement a more reliable change of access mode.

The solutions enable the operator to have visibility about situations where the user or the network force the UE to change access mode but this results into the UE not being able to access any network, hence not being able to use any service. The solutions enable the operator to, for example, design cell reselection policies in a way that a UE trying to register to an NPN will try to reselect a different, e.g., PN, network if the access to the NPN fails.

### BRIEF DESCRIPTION OF THE DRAWINGS

FIG. 1 illustrates cross-network mobility between a PNI-NPN and a public network.

FIG. 2 illustrates a scenario to change between a PLMN and SNPN.

FIG. 3 illustrates a method performed by a user equipment, UE, or, more generally, a wireless device FIG. 4 illustrates an example method carried out by a network node.

FIG. 5 shows an example of a communication system in accordance with some embodiments.

FIG. 6 shows a UE in accordance with some embodiments.

FIG. 7 shows a network node in accordance with some embodiments.

FIG. 8 is a block diagram of a host according to one or more embodiments.

FIG. 9 is a block diagram illustrating a virtualization environment in which functions implemented by some embodiments may be virtualized.

FIG. 10 shows a communication diagram of a host communicating via a network node with a UE over a partially wireless connection in accordance with some embodiments.

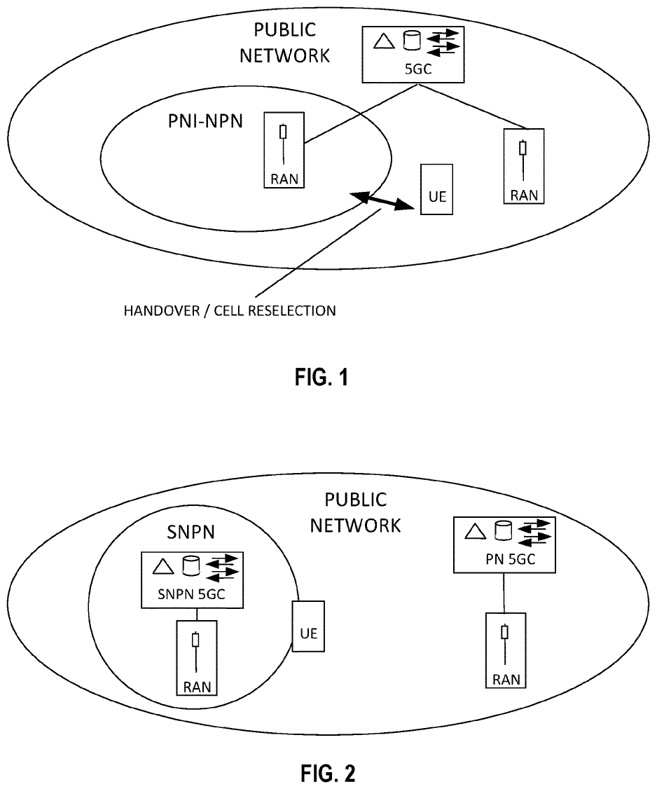

### DETAILED DESCRIPTION

In this document, the terms private networks, non-public network (NPN), and stand-alone non-public network (SNPN) should generally be considered to be interchangeable. While an SNPN operates differently from a PNI-NPN in several respects, the techniques described herein may be applied to operation in or with respect to either.

An SNPN network herein covers the scenario when a cell advertises a PLMN+NID in NPN-Identity in SIB1.

In this document, “out of coverage” means that a UE is unable to find a suitable cell for accessing a network according to a currently requested or desired access mode. The term “access mode,” as used herein, refers to the use of a subscription to access a network, with the understanding that a UE may have multiple subscriptions, to different network and/or types of network (e.g., public vs. private). Thus, a “change of access mode” can mean one or both of a UE's change of network selection access mode as between UE being in “SNPN access mode”, as defined in 3GPP TS 23.501 [1], and UE not being in SNPN access mode, as well as a UE changing use of subscription, e.g., between different SNPN subscriptions or between PLMN subscriptions. Common to all of these is that a change of access mode may force the UE to change the radio capabilities and/or radio resources (e.g., cells) it uses to access a network in accordance with a given subscription, as the radio resources allowed and/or accessible for use ma vary from one network or type of network to another.

This document describes methods performed by the wireless terminal, so-called User Equipment (UE) capable of mobility between Public Network (PN) and NPN or accessing both PN and NPN or multiple NPNs.

When an application or other entity (e.g., network entities) requests a UE in a first network, e.g., PN, to change its access mode, the UE will attempt to register to a second network, e.g., NPN. If the UE does not find a suitable cell in the second network, the UE will experience an OoC condition. According to various embodiments of the presently disclosed techniques, the UE logs an indication that the UE has experienced an OoC condition and/or logs associated information and measurements. This indication and/or information may be logged in SON/MDT UE reports, e.g., RA report or a CEF report, while attempting to change the access mode. In addition, the UE may log information indicating that the out-of-coverage condition occurred due to a request to change the access mode from one network to another network.

An assumption for a UE performing the following method is that the UE has subscriptions to multiple networks. This can be any combination of public networks, PNI-NPN networks and SNPN networks. According to some embodiments, a method carried out by a UE may include some or all of the following:
1) The UE is connected/registered to the first network e.g., PN.
2) The UE receives a request/indication from an application/an entity (in a non-limiting example the request may come from application server or from a network entity). This request triggers and mandates the UE to change its access mode if the change implies a need to select a different type of network, i.e., between selecting SNPN and PLMN e.g., perform registration to the second network e.g., SNPN (which also can involve a change of used subscription).
   In an embodiment, the UE is mandated to change its access mode at a specific time or location.
   In an embodiment, the UE is mandated to change its access mode temporarily (e.g., for a period of time).
3) The UE experiences the OoC of a suitable cell i.e., fails to find a suitable cell in the second network e.g., SNPN.
4) In the main embodiment, the UE logs information and measurements pertained to the OoC occurred due to a change of access mode in SON report(s) e.g., in RA report or a CEF report or MHI report or a dedicated report designed for logging out-of-coverage information in a situation that UE is requested to change the access mode to another network.
   In an embodiment, upon new access mode attempt to the second network, the UE determines whether the NPN identifier(s) (e.g., NID or a list of NIDs) of the second network (SNPN) is/are different from the identifier(s) of the first network. If the UE determines that the NPN identifier(s) (e.g., NID or a list of NIDs) of the second network (SNPN) is/are the different from the identifier(s) of the first network, the UE will delete the SON/MDT report(s) collected for the first network in the UE variable(s) and stores the logged OoC in SON/MDT reports associated to the second network in the empty variable.
   In another embodiment, upon new access mode attempt to the second network, the UE determines whether the NPN identifier(s) (e.g., NID or a list of NIDs) of the second network (SNPN) is/are different from the identifier(s) of the first network. If the UE determines that the NPN identifier(s) (e.g., NID or a list of NIDs) of the second network (SNPN) is/are different from the identifier(s) of the first network, the UE will log the new logged OoC data in SON/MDT reports with associated network identity e.g., npn-identityInfo (SNPN ID) inclusion. Note, the NPNN identity logged is the identity of the network that the UE was forced to select and register to, but that is not available at radio level. With this, the UE shares the associated UE variables with new network temporarily without UE memory extension before deleting the old collected data. The UE isolates the new collected information associated for the new registered network e.g., SNPN. Moreover, the UE ensures no loss of information by storing the logged OoC in SON/MDT reports for the second network e.g., SNPN.
   In yet another embodiment, upon new access mode attempt to the second network, the UE determines whether the NPN identifier(s) (e.g., NID or a list of NIDs) of the second network (SNPN) is/are different from the identifier(s) of the first network. If the UE determines that the NPN identifier(s) (e.g., NID or a list of NIDs) of the second network (SNPN) is/are the different from the identifier(s) of the first network, the UE will store/log the new logged OoC data in SON/MDT reports with associated to the second network in the new variable.
5) In another embodiment, the UE then reports the associated collected OoC information for the second network (SNPN) in the future when it successfully connects to the second network.
6) In another embodiment the UE may report the logged information concerning the second network, as soon as it reconnects to any network, assuming that such new serving network is able to retrieve such logs.
7) In another embodiment, the UE then reports any associated collected OoC information for the first network (PN) in the future when it successfully re-connects to the first network.

In variants of the above, the UE may log the OoC-related information on a per-subscription and/or per-access-mode basis. In other words, the UE can be in-coverage for one access mode/subscription while OoC for another access mode/subscription. The per-subscription or even per-network OoC can be related to the UE radio capabilities, which also may be tied to the network (e.g., in case UE need to report a subset of the information that should have been logged, due to its capabilities or due to the size of information to be collected and reported or for any other reasons leading to a selection of a subset of the information to be logged). The per-subscription or even per-network OoC can be related to general coverage but also related to spectrum used by each network,

In various embodiments, the OoC-related information that is logged may include any, some, or all of the following:
The UE logs duration of being in OoC.
The UE logs list of access mode change failure cause values from AS level.
The UE logs its location at the time the OoC was detected.
The UE logs the reason for changing the access mode, e.g., change of access mode:
   upon receiving a request from an NPN service/application from upper layer, or
   upon a request from received from network elements e.g., from core network, or
   upon moving to a specific location, or
   upon being in a specific time period.
The UE logs whether the UE has ability to make measurements related to new access mode before changing access mode.
   Information also indicates if such pre-measurements was done

In some embodiments, if the application/entity continues requesting a change in the access mode while the UE is still experiencing the OoC, the UE alarms the application/entities to resign its mandate.

In a dependent embodiment, the UE resigns its mandate after certain time. In other words, the UE stops attempting to comply with the requested change in access mode after a pre-determined time, or after a time that may be included in or with the request. In various embodiments, the time value for resigning this mandate may be configured by the operator or other units, either via NAS or AS signalling.

In some embodiments, the UE logs the time from which an OoC situation started till the time when coverage was regained, namely till the time when a suitable cell was found to connect. In some embodiments, the time from which the OoC starts is a time when the UE is at the first network, e.g., a PN) and when the UE loses coverage with the first network. In this case the UE may be forced to attempt to register to a second network (e.g., an NPN), while the UE is OoC of the first network.

In some embodiments, the time from which the OoC starts may be measured from a time when the UE begins trying to access a second network, without succeeding. Namely, the OoC start time coincides with the time when the UE tries to change its access mode.

Signaling Solution for Fetching Out-of-Coverage Information/Report from the UE

In some embodiments, a UE with logged out-of-coverage information indicates the availability of the report to the network after checking the identity of the network. Whether the identity of the current registered network is equivalent to the identity of the network for which the out-of-coverage event is observed.

In some embodiments, the UE flags the availability of logged information only if the identity of the current network is the same as the identity of the network for which the out-of-coverage event is observed. In other embodiments, the UE flags the availability of logged information independently of whether the identity of the current network is the same as the identity of the network for which the out-of-coverage event is observed.

The network, upon receiving the availability indication from the UE, sends a request to fetch the out-of-coverage information/report from the UE. In a non-limiting example, the out-of-coverage information/report request can be sent via UE InformationRequest procedure.

Upon receiving the request to fetch the out-of-coverage information/report from the network, the UE sends the concerned information/report as part of UE InformationResponse message to the network.

### Example Implementation 1

In this non-limiting example implementation, information and measurements pertaining to an out-of-coverage condition that arises when the UE is requested to change the access mode are logged as part of a new and dedicated report implemented as part of UE information response procedure described in 3GPP TS 38.331:

```
--------------------------- begin proposed 3GPP specification -----------------------------------
      UEInformationResponse
The UEInformationResponse message is used by the UE to transfer information requested by the
network.
  Signalling radio bearer: SRB1 or SRB2 (when logged measurement information is included)
  RLC-SAP: AM
  Logical channel: DCCH
  Direction: UE to network
```

UEInformation Response message

-- ASN1START
-- TAG-UEINFORMATIONRESPONSE-START

| | |
|---|---|
| UEInformationResponse-r16 ::= | SEQUENCE { |
| rrc-TransactionIdentifier | RRC-TransactionIdentifier, |

| | |
|---|---|
| criticalExtensions | CHOICE { |

| | |
|---|---|
| ueInformationResponse-r16 | UEInformationResponse-r16-IEs, |

| | |
|---|---|
| criticalExtensionsFuture | SEQUENCE { } |

}
}

| UEInformationResponse-r16-IEs ::= | SEQUENCE { | |
|---|---|---|
| measResultIdleEUTRA-r16 | MeasResultIdleEUTRA-r16 | OPTIONAL, |

| | | |
|---|---|---|
| measResultIdleNR-r16 | MeasResultIdleNR-r16 | OPTIONAL, |
| logMeasReport-r16 | LogMeasReport-r16 | OPTIONAL, |
| connEstFailReport-r16 | ConnEstFailReport-r16 | OPTIONAL, |

| | | |
|---|---|---|
| ra-ReportList-r16 | RA-ReportList-r16 | OPTIONAL, |
| rlf-Report-r16 | RLF-Report-r16 | OPTIONAL, |

| | | |
|---|---|---|
| mobilityHistoryReport-r16 | MobilityHistoryReport-r16 | OPTIONAL, |

| | | |
|---|---|---|
| lateNonCriticalExtension | OCTET STRING | OPTIONAL, |

| | | |
|---|---|---|
| nonCriticalExtension | UEInformationResponse-v1700-IEs | OPTIONAL |

}

| | |
|---|---|
| UEInformationResponse-v1700-IEs ::= | SEQUENCE { |

| | | |
|---|---|---|
| successHO-Report-r17 | SuccessHO-Report-r17 | OPTIONAL, |

| | | |
|---|---|---|
| connEstFailReportList-r17 | ConnEstFailReportList-r17 | OPTIONAL |

| | | |
|---|---|---|
| coarseLocationInfo-r17 | OCTET STRING | OPTIONAL, |

| | | |
|---|---|---|
| nonCriticalExtension | UEInformationResponse-v1800-IEs | OPTIONAL |

}

| | |
|---|---|
| UEInformationResponse-v1800-IEs ::= | SEQUENCE { |

| | | |
|---|---|---|
| outOfCoverage-Report-r18 | OutOfCoverage-Report-r18 | OPTIONAL, |

| | | |
|---|---|---|
| nonCriticalExtension | SEQUENCE { } | OPTIONAL |

}

| | |
|---|---|
| OutOfCoverage-Report-r18 ::= | SEQUENCE { |

| | | |
|---|---|---|
| timePeriod-r18 | TimePeriod-r18, | OPTIONAL, |

| | | |
|---|---|---|
| timeSinceOutofCoverage-r18 | TimeSinceOutofCoverage-r18, | OPTIONAL, |

| | | |
|---|---|---|
| registered-plmn-Identity-r18 | PLMN-Identity | OPTIONAL, |

| | | |
|---|---|---|
| requested-npn-Identity-r18 | NPN-IdentityInfoList-r16 | OPTIONAL, |

| | |
|---|---|
| accessModeChangeRequest-r18 | ENUMERATED {true} |

OPTIONAL,

| | |
|---|---|
| accessModeChangeRequestCause-r18 | ENUMERATED {requestFromUpperLayer, |

requestFromNetwork, locationBased, timeBased, spare3, spare2, spare1 }
OPTIONAL,

| | |
|---|---|
| selectedCellInfo-r18 | SEQUENCE { |

| selectedCellId-r18 | CGI-Info-Logging-r16, | |
|---|---|---|
| selectedCellMeas-r18 | MeasResultSelectedCell-r18 | OPTIONAL |

},

| | |
|---|---|
| MeasResultSelectedCell-r18 ::= | SEQUENCE { |

| | |
|---|---|
| measResult-r18 | SEQUENCE { |
| cellResults-r18 | SEQUENCE{ |

| | | |
|---|---|---|
| resultsSSB-Cell-r18 | MeasQuantityResults | OPTIONAL, |
| resultsCSI-RS-Cell-r18 | MeasQuantityResults | OPTIONAL |

},

| | |
|---|---|
| rsIndexResults-r18 | SEQUENCE{ |

| | | |
|---|---|---|
| resultsSSB-Indexes-r18 | ResultsPerSSB-IndexList | OPTIONAL, |

| | | |
|---|---|---|
| resultsCSI-RS-Indexes-r18 | ResultsPerCSI-RS-IndexList | OPTIONAL |

```
    }
  }
```

| | |
|---|---|
| } | OPTIONAL, |

| | | |
|---|---|---|
| measResult-r18 | measResultNeighCells-r17 | OPTIONAL, |

| | | |
|---|---|---|
| locationInfo-r18 | LocationInfo-r16 | OPTIONAL, |

...
}

| | |
|---|---|
| LogMeasReport-r16 ::= | SEQUENCE { |

| | |
|---|---|
| absoluteTimeStamp-r16 | AbsoluteTimeInfo-r16, |

| | |
|---|---|
| traceReference-r16 | TraceReference-r16, |

| | |
|---|---|
| traceRecordingSessionRef-r16 | OCTET STRING (SIZE (2)), |

| | |
|---|---|
| tce-Id-r16 | OCTET STRING (SIZE (1)), |

| logMeasInfoList-r16 | LogMeasInfoList-r16, | |
|---|---|---|
| logMeasAvailable-r16 | ENUMERATED {true} | OPTIONAL, |
| logMeasAvailableBT-r16 | ENUMERATED {true} | OPTIONAL, |

| | | |
|---|---|---|
| logMeasAvailableWLAN-r16 | ENUMERATED {true} | OPTIONAL, |

...
}
-- TAG-UEINFORMATIONRESPONSE-STOP
-- ASN1STOP

OutOfCoverage-Report field descriptions
timePeriod
This field refers to the time period the UE was out of coverage e.g., from receiving a request to
change the access mode to the end time of the out of coverage i.e., UE finds a suitable cell.
measResult
This field refers to the neighbour cell measurements when a suitable cell is selected after the out-of-
coverage situation.
timeSinceOutofCoverage
This field is used to indicate the time that elapsed since logging the out-of-coverage information.
Value in seconds. The maximum value 172800 means 172800 s or longer.
registered-plmn-Identity
the PLMN to which the UE was registered before receiving the access mode change request
requested-npn-Identity
the NPN identity to which the UE is requested to register but no suitable cell is found
accessModeChangeRequest
this field indicates whether the access mode change request is received by the UE that led to the out-
of-coverage condition
accessModeChangeRequestCause
This field indicates the reason for the change of the access mode
selectedCellInfo
This field is used to log the information (identity and measurements) of the first cell selected after the
out-of-coverage situation

| | | |
|---|---|---|
| 1.1.1.1 | - | VarOutOfCoverage |

```
  The UE variable VarOutOfCoverage includes the out-of-coverage information for the
  coverage issues occurring during the change of access mode.
```

VarConnEstFailReport UE variable

```
  -- ASN1START
  -- TAG-VARCONNESTFAILREPORT-START
  VarOutOfCoverage-r16 ::= SEQUENCE {
```

| | |
|---|---|
| OutOfCoverage-Report-r18 | OutOfCoverage-Report-r18, |

| | |
|---|---|
| npn-Identity-r16 | NPN-Identity |

```
  }
  -- TAG-VARCONNESTFAILREPORT-STOP
  -- ASN1STOP
-------------------------------------- end proposed 3GPP specification -------------------------------------
```

| | |
|---|---|
| 1.2 | Example implementation 2 |

A non-limiting example implementation in one of SON reports i.e., RA report collecting RA report
without mixing the RA reports from two independent networks (PN and SNPN or two SNPN) in the
same VarRA-Report is given below:
----------------------------------- begin proposed 3GPP specification ----------------------------------------

| | |
|---|---|
| 5.7.10.4 | Actions upon successful completion of a random-access procedure or on |
| | completion of a request of on-demand system information |

```
  Upon successfully performing random-access procedure initialized with 4-step or 2-step RA
  type, or upon failed or successfully completed on-demand system information acquisition
  procedure in RRC_IDLE or RRC_INACTIVE state, the UE shall:
```

| | |
|---|---|
| 1> | if the RPLMN or the PLMN selected by upper layers (see TS24.501 [23]) from the |
| | PLMN(s) included in the plmn-IdentityList in SIB1 is not included in plmn-IdentityList |
| | stored in a non-empty VarRA-Report: |
| | 2>if the RPLMN or the PLMN selected by upper layers (see TS24.501 [23]) from the |
| | PLMN(s) included in the npn-IdentityInfoList in SIB1 is not included in npn- |
| | IdentityInfoList stored in a non-empty VarRA-Report |

| | |
|---|---|
| 2> | clear the information included in VarRA-Report; |

2>append the following contents associated to the failed random-access procedure as

a new entry in the VarRA-Report.

| | |
|---|---|
| 3> | if the list of EPLMNs has been stored by the UE: |

| | |
|---|---|
| 4> | set the plmn-IdentityList or npn-IdentityInfoList to include the list of |
| | EPLMNs stored by the UE (i.e., includes the RPLMN) without exceeding |
| | the limit of maxPLMN; |
| 4> | set the failurecause due to changing the access mode in accordance with |
| | the information received from upper layers; |

| | |
|---|---|
| 1> | if the number of RA-Report entries stored in the ra-ReportList in VarRA-Report is less |
| | than maxRAReport: |

| | |
|---|---|
| 2> | if the number of PLMN entries in plmn-IdentityList and npn-IdentityInfoList stored in |
| | VarRA-Report is less than maxPLMN; or |
| 2> | if the number of PLMN entries in plmn-IdentityList and npn-IdentityInfoList stored in |
| | VarRA-Report is equal to maxPLMN and the list of EPLMNs is subset of or equal to |
| | the plmn-IdentityList stored in VarRA-Report: |

| | |
|---|---|
| 3> | append the following contents associated to the successfully completed random- |
| | access procedure or the failed or successfully completed on-demand system |
| | information acquisition procedure as a new entry in the VarRA-Report: |

| | |
|---|---|
| 4> | if the list of EPLMNs has been stored by the UE: |

| | |
|---|---|
| 5> | set the plmn-IdentityList to include the list of EPLMNs stored by the UE |
| | (i.e., includes the RPLMN) without exceeding the limit of maxPLMN; |

| | |
|---|---|
| 4> | else: |

| | |
|---|---|
| 5> | set the plmn-Identity, in plmn-IdentityList and npn-IdentityInfoList, to the |
| | PLMN selected by upper layers (see TS 24.501 [23]) from the PLMN(s) |
| | included in the plmn-IdentityInfoList in SIB1; or |
| 5> | set the npn-IdentityInfoList, in npn-IdentityInfoList, to the PLMN selected |
| | by upper layers (see TS 24.501 [23]) from the PLMN(s) included in the |
| | npn-IdentityInfoList in SIB1; |

| | |
|---|---|
| 4> | set the cellId to the global cell identity and the tracking area code, if available, |
| | otherwise to the physical cell identity and carrier frequency of the cell in which |
| | the corresponding random-access preamble was transmitted; |
| 4> | if the corresponding random-access procedure was performed on an SCell of |
| | MCG: |

| | |
|---|---|
| 5> | set the spCellId to the global cell identity of the PCell; |

| | |
|---|---|
| 4> | if the corresponding random-access procedure was performed on an SCell of |
| | SCG: |

| | |
|---|---|
| 5> | set the spCellId to the global cell identity of the PSCell; |

| | |
|---|---|
| 4> | set the raPurpose to include the purpose of triggering the random-access |
| | procedure; |
| 4> | set the ra-InformationCommon as specified in clause 5.7.10.5. |

```
  The UE may discard the random access report information, i.e., release the UE variable
  VarRA-Report, 48 hours after the last successful random access procedure or the failed or
  successfully completed on-demand system information acquisition procedure related
  information is added to the VarRA-Report.
```

| | |
|---|---|
| NOTE 1: | The UE does not log the RA information in the RA report if the triggering event of |

the random access is consistent UL LBT on SpCell as specified in TS 38.321 [6].

------------------------------------------ end proposed 3GPP specification -----------------------------------

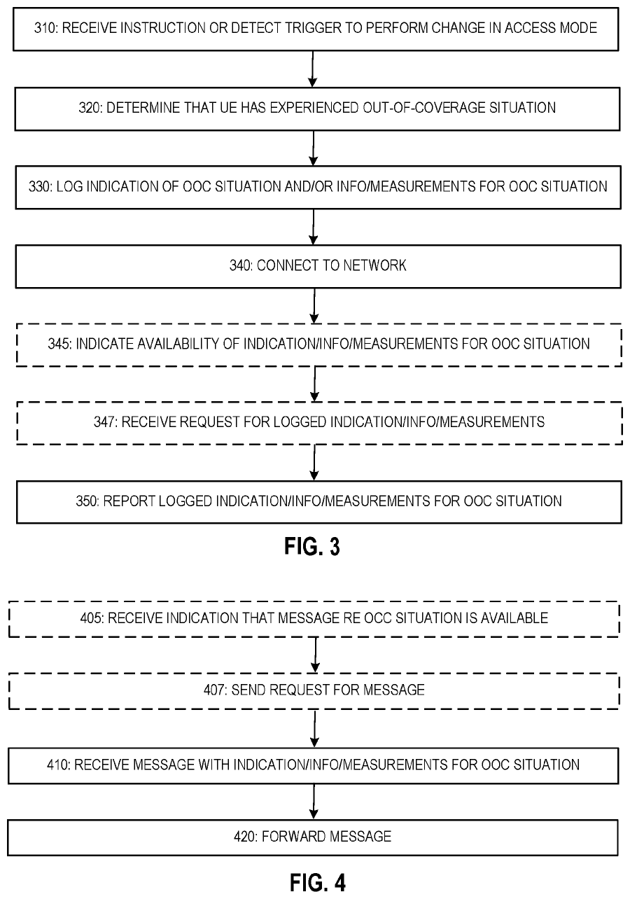

In view of the details and examples provided above, it should be appreciated that FIG. 3 illustrates a method performed by a user equipment, UE, or, more generally, a wireless device. For the purposes of the present disclosure, the term “UE” should be taken to refer to any access terminal that can connect to a wireless network and, in the present context, that can have multiple subscriptions to different networks and/or networks of different types, such as public networks and non-public networks. Note that the method illustrated in FIG. 3 and described below is intended to be a generalization of and to encompass many, if not all, of the UE-related techniques described above. Thus, while the figure and the following description may use terminology that differs somewhat from the terminology used above, the terminology used above should be understood to be at least synonymous with, if not broader than similar or clearly related terminology used above.

As shown at block 310, the method begins with receiving an instruction or detecting a trigger to change the UE's access mode, where the change in the UE's access mode involves a change in radio resources available to the UE for accessing a network. This instruction may be a “request” or “command” sent from a network to which the UE is currently connected, in some embodiments. The detected trigger may be, for example, the satisfaction of one or more pre-established conditions, such as the elapsing of a certain time interval or the arrival of a certain time, or the occurrence of a specific event or arrival of the UE at a specific location, etc. In the discussion above, both the “receiving an instruction” and “detecting a trigger” alternatives are generally referred to as a “request” to change access mode.

The change in access mode at issue here may comprise changing from an access mode in which the UE connects to a public network to an access mode in which the UE connects to a non-public network, in some embodiments or instances. In others, the change in access mode may comprise changing from an access mode in which the UE connects to a first non-public network to an access mode in which the UE connects to a second non-public network. In some embodiments or instances, the change in access mode may necessitate a change in radio bands, which may actually be the cause of the OoC situation, if the UE is unable to support a certain band.

As shown at block 320, the method further comprises determining that the UE has experienced an out-of-coverage (OoC) situation with respect to the change in access mode. This may comprise, for example, determining that the UE is unable to find or access any cells associated with a target network of the change in access mode. As discussed above, this may be because there are simply no detected signals for cells in the target network for the change in access mode, or because the UE is not allowed to access cells that are detected, etc. Thus, an OoC may be generally understood as a lack of suitable cells for the UE to connect to, given the target network/subscription for the change in access mode.

As shown at block 330, the method still further comprises logging, for subsequent reporting, an indication of the OC situation and/or information and/or measurements pertaining to the OoC situation.

In some embodiments or instances, the method further comprises connecting to a network, subsequently to said logging, as shown at block 340, and reporting the logged indication and/or measurements and/or information to the network, as shown at block 350. In some embodiments, the UE may first indicate, to the network availability of the logged indication and/or measurements and/or information, as shown at block 345, and receive a request for the logged indication and/or measurements and/or information, as shown at block 347, such that the reporting at block 350 responsive to a request for the logged indication and/or measurements and/or information. Note that in some embodiments or instances, the reporting may be conditioned on the network to which the UE subsequently connects being the target network of the change in access mode. In others, the UE may send the report to a different network, on the assumption or understanding that it will be forwarded to the proper network.

In various embodiments or instances, as was discussed above, the logged indication and/or measurements and/or information comprises any one or more of any of the following:
an OoC indication;
an indication of a cause for the OoC situation;
an identity of the network for which the OoC situation is encountered;
a time elapsed while in the OoC situation;
location information for a location at which the OoC situation is encountered;
an indication of a type of event occurring after the OoC situation;
an indication of a reason for changing the access mode; and
an indication of whether the UE was able to make measurements related to the target access mode before changing access mode.

Variations of and/or additions to the above are also possible.

In some embodiments, the UE may determine that the change in access mode is no longer required, or should no longer be attempted. This was referred to above as the UE “resigning its mandate.” This may comprise, for example, determining that a pre-determined time has elapsed since attempting the change in access mode. At this point, the UE may, for example, revert to a previous access mode or an alternative changed access mode, in response to determining that the pre-determined time has elapsed.

Most of the discussion above focuses on actions taken by a UE. It will be appreciated, however, that corresponding actions, and thus corresponding methods, may be implemented by one or more network nodes, whether by a base station (e.g., a 5G gNB) or some other RAN node or core network node, such as a SON node.

FIG. 4 illustrates an example method carried out by a network node. The method comprises, as shown at block 410, receiving, from a user equipment, a message comprising an indication of an out-of-coverage (OoC) situation encountered by the user equipment in connection with an attempted change in access mode and/or information and/or measurements pertaining to the OoC situation, where the change in the UE's access mode involves a change in radio resources available to the UE for accessing a network.

As shown at block 420, the method may comprise, in some embodiments or instances, forwarding the message to a self-organizing network (SON) node.

In some embodiments or instances, the method may comprise, prior to the receiving of the message, receiving an indication from the user equipment that the message is available and, responsive to the indication that the message is available, sending a request to the user equipment for the message. These steps are shown at blocks 405 and 407.

In some embodiments, the network node belongs to a different communication network than a communication network to which the OoC situation relates and wherein the method further comprises forwarding the message to the communication network to which the OoC situation relates. In some embodiments, such as in some embodiments where the network node is a SON node, the method may further comprise, based on the message, adapting a configuration of a communication network to which the OoC situation relates.

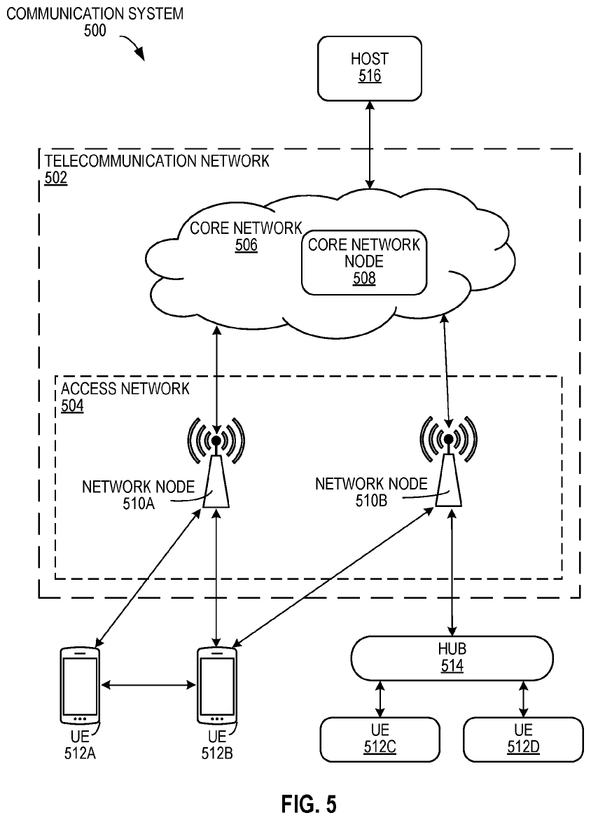

FIG. 5 shows an example of a communication system 500 in accordance with some embodiments. This communication system may provide a public network, or a non-public network (NPN), or both, in various instantiations.

In the example, the communication system 500 includes a telecommunication network 502 that includes an access network 504, such as a Radio Access Network (RAN), and a core network 506, which includes one or more core network nodes 508. The access network 504 includes one or more access network nodes, such as network nodes 510A and 510B (one or more of which may be generally referred to as network nodes 510), or any other similar Third Generation Partnership Project (3GPP) access node or non-3GPP Access Point (AP). The network nodes 510 facilitate direct or indirect connection of User Equipment (UE), such as by connecting UEs 512A, 512B, 512C, and 512D (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system 500 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 5G, or 6G) standards, or any applicable future generation standard (e.g., Sixth Generation (6G)); Wireless Local Area Network (WLAN) standards, such as the Institute of Electrical and Electronics Engineers (IEEE) 902.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 502 is a cellular network that implements 3GPP standardized features. Accordingly, the telecommunication network 502 may support network slicing to provide different logical networks to different devices that are connected to the telecommunication network 502. For example, the telecommunication network 502 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 514 communicates with the access network 504 to facilitate indirect communication between one or more UEs (e.g., UE 512C and/or 512D) and network nodes (e.g., network node 510B). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a Virtual Reality (VR) headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510B. The hub 514 may also allow for a different communication scheme and/or schedule between the hub 514 and UEs (e.g., UE 512C and/or 512D), and between the hub 514 and the core network 506. In other examples, the hub 514 is connected to the core network 506 and/or one or more UEs via a wired connection. Moreover, the hub 514 may be configured to connect to a Machine-to-Machine (M2M) service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510B. In other embodiments, the hub 514 may be a non-dedicated hub—that is, a device which is capable of operating to route communications between the UEs and the network node 510B, but which is additionally capable of operating as a communication start and/or end point for certain data channels.

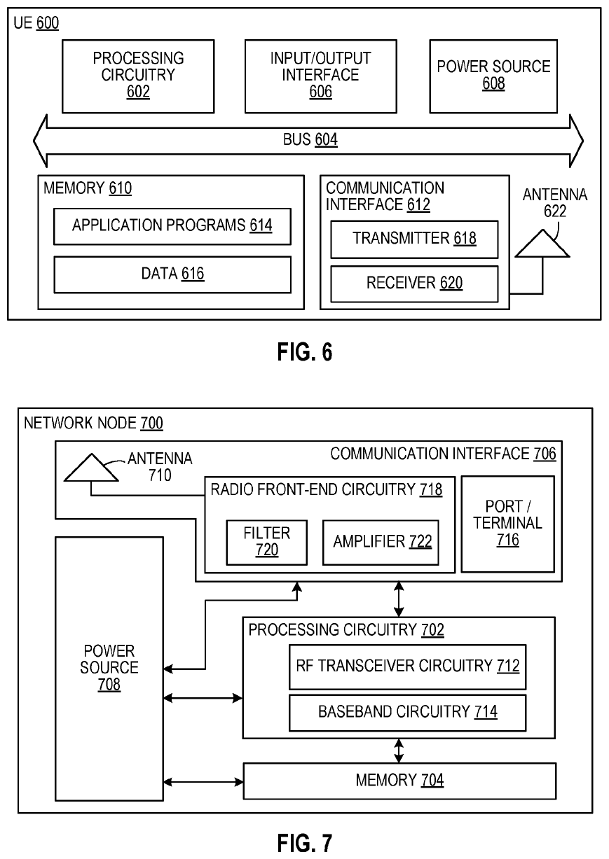

FIG. 6 shows a UE 600 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 602 may include multiple Central Processing Units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging the power source 608. Power circuitry may perform any formatting, converting, or other modification to the power from the power source 608 to make the power suitable for the respective components of the UE 600 to which power is supplied.

The memory 610 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 610 may allow the UE 600 to access instructions, application programs, and the like stored on transitory or non-transitory memory media, to off-load data, or to upload data. An article of manufacture, such as one utilizing a communication system, may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., the antenna 622) and may share circuit components, software, or firmware, or alternatively be implemented separately.

In the illustrated embodiment, communication functions of the communication interface 612 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 902.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 612, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on Its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 7 shows a network node 700 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, aPs (e.g., radio aPs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 6G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes processing circuitry 702, memory 704, a communication interface 706, and a power source 708. The network node 700 may be composed of multiple physically separate components (e.g., a Node B component and an RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 700 may be configured to support multiple RATs. In such embodiments, some components may be duplicated (e.g., separate memory 704 for different RATs) and some components may be reused (e.g., an antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 700.

The processing circuitry 702 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 700 components, such as the memory 704, to provide network node 700 functionality.

In some embodiments, the processing circuitry 702 includes a System on a Chip (SOC). In some embodiments, the processing circuitry 702 includes one or more of Radio Frequency (RF) transceiver circuitry 712 and baseband processing circuitry 714. In some embodiments, the RF transceiver circuitry 712 and the baseband processing circuitry 714 may be on separate chips (or sets of chips), boards, or units, such as radio units and digital units. In alternative embodiments, part or all of the RF transceiver circuitry 712 and the baseband processing circuitry 714 may be on the same chip or set of chips, boards, or units.

The memory 704 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and the memory 704 are integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. The radio front-end circuitry 718 comprises filters 720 and amplifiers 722. The radio front-end circuitry 718 may be connected to the antenna 710 and the processing circuitry 702. The radio front-end circuitry 718 may be configured to condition signals communicated between the antenna 710 and the processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of the filters 720 and/or the amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface 706 may comprise different components and/or different combinations of components.

In certain alternative embodiments, the network node 700 does not include separate radio front-end circuitry 718; instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes the one or more ports or terminals 716, the radio front-end circuitry 718, and the RF transceiver circuitry 712 as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, the communication interface 706, and/or the processing circuitry 702 may be configured to perform any receiving operations and/or certain obtaining operations described herein as being performed by the network node 700. Any information, data, and/or signals may be received from a UE, another network node, and/or any other network equipment. Similarly, the antenna 710, the communication interface 706, and/or the processing circuitry 702 may be configured to perform any transmitting operations described herein as being performed by the network node 700. Any information, data, and/or signals may be transmitted to a UE, another network node, and/or any other network equipment.

The power source 708 provides power to the various components of the network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid or an electricity outlet) via input circuitry or an interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

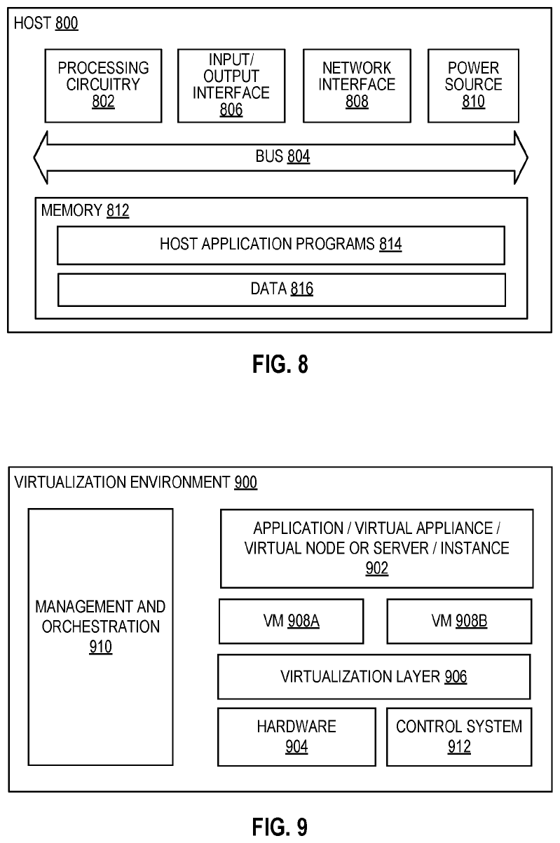

FIG. 8 is a block diagram of a host 800, which may be an embodiment of the host 516 of FIG. 5, in accordance with various aspects described herein. As used herein, the host 800 may be or comprise various combinations of hardware and/or software including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and memory 812. Other components may be included in other embodiments. Features of these components may be substantially similar to those described with respect to the devices of previous figures, such as FIGS. 6 and 7, such that the descriptions thereof are generally applicable to the corresponding components of the host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 814 may also provide for user authentication and licensing checks and may periodically report health, routes, and content availability to a central node, such as a device in or on the edge of a core network. Accordingly, the host 800 may select and/or indicate a different host for Over-The-Top (OTT) services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 800 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or VM Monitors (VMMs)), provide VMs 908A and 908B (one or more of which may be generally referred to as VMs 908), and/or perform any of the functions, features, and/or benefits described in relation with some embodiments described herein. The virtualization layer 906 may present a virtual operating platform that appears like networking hardware to the VMs 908.

The VMs 908 comprise virtual processing, virtual memory, virtual networking, or interface and virtual storage, and may be run by a corresponding virtualization layer 906. Different embodiments of the instance of a virtual appliance 902 may be implemented on one or more of the VMs 908, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 908 may be a software implementation of a physical machine that runs programs as if they were executing on a physical, non-virtualized machine. Each of the VMs 908, and that part of the hardware 904 that executes that VM, be it hardware dedicated to that VM and/or hardware shared by that VM with others of the VMs 908, forms separate virtual network elements. Still in the context of NFV, a virtual network function is responsible for handling specific network functions that run in one or more VMs 908 on top of the hardware 904 and corresponds to the application 902.

The hardware 904 may be implemented in a standalone network node with generic or specific components. The hardware 904 may implement some functions via virtualization. Alternatively, the hardware 904 may be part of a larger cluster of hardware (e.g., such as in a data center or CPE) where many hardware nodes work together and are managed via management and orchestration 910, which, among others, oversees lifecycle management of the applications 902. In some embodiments, the hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 912 which may alternatively be used for communication between hardware nodes and radio units.

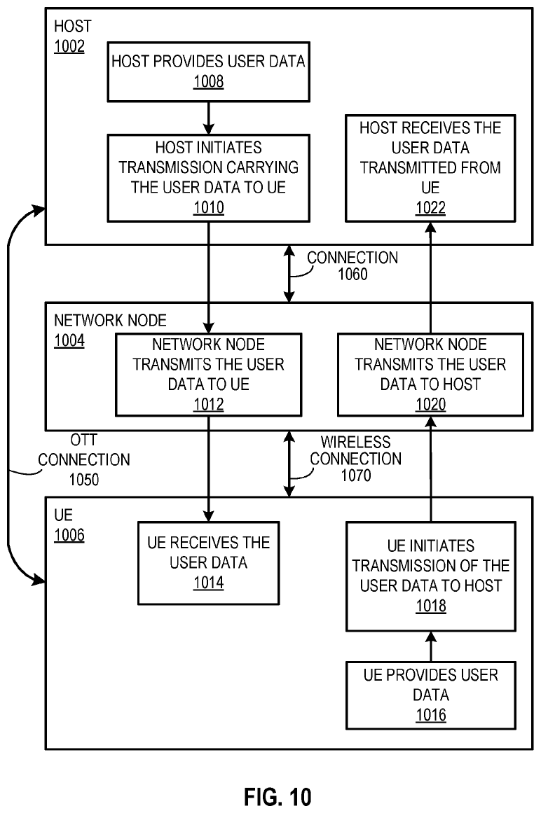

FIG. 10 shows a communication diagram of a host 1002 communicating via a network node 1004 with a UE 1006 over a partially wireless connection in accordance with some embodiments. Example implementations, in accordance with various embodiments, of the UE (such as the UE 512A of FIG. 5 and/or the UE 600 of FIG. 6), the network node (such as the network node 510A of FIG. 5 and/or the network node 700 of FIG. 7), and the host (such as the host 516 of FIG. 5 and/or the host 800 of FIG. 8) discussed in the preceding paragraphs will now be described with reference to FIG. 10.

Like the host 800, embodiments of the host 1002 include hardware, such as a communication interface, processing circuitry, and memory. The host 1002 also includes software, which is stored in or is accessible by the host 1002 and executable by the processing circuitry. The software includes a host application that may be operable to provide a service to a remote user, such as the UE 1006 connecting via an OTT connection 1050 extending between the UE 1006 and the host 1002. In providing the service to the remote user, a host application may provide user data which is transmitted using the OTT connection 1050.

The network node 1004 includes hardware enabling it to communicate with the host 1002 and the UE 1006 via a connection 1060. The connection 1060 may be direct or pass through a core network (like the core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by the UE 1006 and executable by the UE's processing circuitry. The software includes a client application, such as a web browser or operator-specific “app” that may be operable to provide a service to a human or non-human user via the UE 1006 with the support of the host 1002. In the host 1002, an executing host application may communicate with the executing client application via the OTT connection 1050 terminating at the UE 1006 and the host 1002. In providing the service to the user, the U″s client application may receive request data from the host application and provide user data in response to the request data. The OTT connection 1050 may transfer both the request data and the user data. The U″s client application may interact with the user to generate the user data that it provides to the host application through the OTT connection 1050.

The OTT connection 1050 may extend via the connection 1060 between the host 1002 and the network node 1004 and via a wireless connection 1070 between the network node 1004 and the UE 1006 to provide the connection between the host 1002 and the UE 1006. The connection 1060 and the wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004 in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR, or

AR which it can broadcast, multicast, or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1050 between the host 1002 and the UE 1006 in response to variations in the measurement results. The measurement procedure and/or the network functionality for reconfiguring the OTT connection 1050 may be implemented in software and hardware of the host 1002 and/or the UE 1006. In some embodiments, sensors (not shown) may be deployed in or in association with other devices through which the OTT connection 1050 passes; the sensors may participate in the measurement procedure by supplying values of the monitored quantities exemplified above, or by supplying values of other physical quantities from which software may compute or estimate the monitored quantities. The reconfiguring of the OTT connection 1050 may include message format, retransmission settings, preferred routing, etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency, and the like by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EXAMPLE EMBODIMENTS

Embodiments of the techniques, apparatuses, and systems described above include, but are not limited to, the following enumerated examples:

### Group A Embodiments

A1. A method performed by a user equipment, UE, the method comprising:
receiving an instruction or detecting a trigger to change the UE's access mode, wherein the change in the UE's access mode involves a change in radio resources available to the UE for accessing a network;
determining that the UE has experienced an out-of-coverage (OoC) situation with respect to the change in access mode; and
logging, for subsequent reporting, an indication of the OoC situation and/or information and/or measurements pertaining to the OoC situation.

A2. The method of example embodiment A1, wherein the change in access mode comprises changing from an access mode in which the UE connects to a public network to an access mode in which the UE connects to a non-public network.

A3. The method of example embodiment A1, wherein the change in access mode comprises changing from an access mode in which the UE connects to a first non-public network to an access mode in which the UE connects to a second non-public network.

A4. The method of any one of example embodiments A1-A3, wherein the change in access mode necessitates a change in radio bands.

A5. The method of any one of example embodiments A1-A4, wherein determining that the UE has experienced an out-of-coverage (OoC) situation comprises determining that the UE is unable to find or access any cells associated with a target network of the change in access mode.

A6. The method of any one of example embodiments A1-A6, wherein the method further comprises: connecting to a network, subsequently to said logging; and reporting the logged indication and/or measurements and/or information to the network.

A7. The method of example embodiment A6, wherein the method comprises indicating, to the network, availability of the logged indication and/or measurements and/or information, and wherein said reporting is responsive to a request for the logged indication and/or measurements and/or information.

A8. The method of example embodiment A6 or A7, wherein said reporting is conditioned on the network being the target network of the change in access mode.

A9. The method of any one of example embodiments A1-A8, wherein the logged indication and/or measurements and/or information comprises any one or more of any of the following:
an OoC indication;
an indication of a cause for the OoC situation;
an identity of the network for which the OoC situation is encountered;
a time elapsed while in the OoC situation;
location information for a location at which the OoC situation is encountered;
an indication of a type of event occurring after the OoC situation;
an indication of a reason for changing the access mode; and
an indication of whether the UE was able to make measurements related to the target access mode before changing access mode.

A10. The method of any one of example embodiments A1-A9, further comprising:
determining that a pre-determined time has elapsed since attempting the change in access mode; and
reverting to a previous access mode or an alternative changed access mode, in response to determining that the pre-determined time has elapsed.

A11. The method of any one of example embodiments A1-A10, wherein the instruction or instructions are received from a network to which the UE is connected.

A12. The method of any one of example embodiments A1-A11, wherein receiving an instruction or detecting a trigger comprises determining that one or more pre-determined conditions for changing access mode have occurred.

A13. The method of any one of example embodiments A1-A12, wherein receiving an instruction or detecting a trigger comprises receiving an instruction to change access mode from a network to which the UE is connected.

### Group B Embodiments

B1. A method performed by a network node, the method comprising:
receiving, from a user equipment, a message comprising an indication of an out-of-coverage (OoC) situation encountered by the user equipment in connection with an attempted change in access mode and/or information and/or measurements pertaining to the OoC situation, wherein the change in the UE's access mode involves a change in radio resources available to the UE for accessing a network.

B2. The method of example embodiment B1, further comprising forwarding the message to a self-organizing network (SON) node.

B3. The method of example embodiment B1 or B2, further comprising, prior to said receiving, receiving an indication from the user equipment that the message is available and, responsive to the indication that the message is available, sending a request to the user equipment for the message.

B4. The method of any of example embodiments B1-B4, wherein the network node belongs to a different communication network than a communication network to which the OoC situation relates and wherein the method further comprises forwarding the message to the communication network to which the OoC situation relates.

B5. The method of any of embodiments B1-B4, further comprising, based on the message, adapting a configuration of a communication network to which the OoC situation relates.

B6. The method of any of the previous embodiments, further comprising:
obtaining user data; and
forwarding the user data to a host computer or a communication device.

### Group C Embodiments

C1. A communication device configured to perform any of the steps of any of the Group A embodiments.

C2. A communication device comprising processing circuitry configured to perform any of the steps of any of the Group A embodiments.

C3. A communication device comprising:
communication circuitry; and
processing circuitry configured to perform any of the steps of any of the Group A embodiments.

C4. A communication device comprising:
processing circuitry configured to perform any of the steps of any of the Group A embodiments; and
power supply circuitry configured to supply power to the communication device.

C5. A communication device comprising:
processing circuitry and memory, the memory containing instructions executable by the processing circuitry whereby the communication device is configured to perform any of the steps of any of the Group A embodiments.

C6. The communication device of any of embodiments C1-C5, wherein the communication device is a wireless communication device.

C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C8. A computer program comprising instructions which, when executed by at least one processor of a communication device, causes the communication device to carry out the steps of any of the Group A embodiments.

C9. A carrier containing the computer program of embodiment C7, wherein the carrier is one of an electronic signal, optical signal, radio signal, or computer readable storage medium.

C10. A network node configured to perform any of the steps of any of the Group B embodiments.

C11. A network node comprising processing circuitry configured to perform any of the steps of any of the Group B embodiments.

C12. A network node comprising:
communication circuitry; and
processing circuitry configured to perform any of the steps of any of the Group B embodiments.

C13. A network node comprising:
processing circuitry configured to perform any of the steps of any of the Group B embodiments;
power supply circuitry configured to supply power to the network node.

C14. A network node comprising:
processing circuitry and memory, the memory containing instructions executable by the processing circuitry whereby the network node is configured to perform any of the steps of any of the Group B embodiments.

C15. The network node of any of embodiments C10-C14, wherein the network node is a base station.

C16. A computer program comprising instructions which, when executed by at least one processor of a network node, causes the network node to carry out the steps of any of the Group B embodiments.

C17. The computer program of embodiment C16, wherein the network node is a base station.

C18. A carrier containing the computer program of any of embodiments C16-C17, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

ABBREVIATIONS

| Abbreviation | Explanation |
|---|---|
| NPN | Non-Public Network |
| PN | Public Network |
| SNPN | Standalone Non-Public Network |
| NID | Network Identifier |
| PNI-NPN | Public Network Integrated Non-Public Network |
| CAG | Closed Access Group |
| SON | Self-organising networks |
| RLF | Radio Link Failure |
| RACH | Random access channel |

1-40. (canceled)

41. A method performed by a user equipment (UE), the method comprising:
receiving an instruction or detecting a trigger to change the UE's access mode, wherein the change in the UE's access mode includes a change in one or more radio resources available to the UE for accessing a network;
determining that the UE has experienced an out-of-coverage (OoC) situation with respect to the change in the UE's access mode; and
logging, for subsequent reporting, an indication of the OoC situation and/or information and/or measurements pertaining to the OoC situation.

42. The method of claim 41, wherein the change in access mode comprises changing from an access mode in which the UE connects to a public network to an access mode in which the UE connects to a non-public network.

43. The method of claim 41, wherein the change in access mode comprises changing from an access mode in which the UE connects to a first non-public network to an access mode in which the UE connects to a second non-public network.

44. The method of claim 41, wherein the change in access mode necessitates a change in radio bands.

45. The method of claim 41, wherein determining that the UE has experienced an OoC situation comprises determining that the UE is unable to find or access any cells associated with a target network of the change in access mode.

46. The method of claim 41, wherein the method further comprises:
connecting to a network, subsequently to said logging; and
reporting the logged indication and/or measurements and/or information to the network.

47. The method of claim 46, wherein the method comprises indicating, to the network, availability of the logged indication and/or measurements and/or information, and wherein said reporting is responsive to a request for the logged indication and/or measurements and/or information.

48. The method of claim 41, wherein the logged indication and/or measurements and/or information comprises any one or more of any of the following:
an OoC indication;
an indication of a cause for the OoC situation;
an identity of the network for which the OoC situation is encountered;
a time elapsed while in the OoC situation;
location information for a location at which the OoC situation is encountered;
an indication of a type of event occurring after the OoC situation;
an indication of a reason for changing the access mode; and
an indication of whether the UE was able to make measurements related to the target access mode before changing access mode.

49. The method of claim 41, further comprising:
determining that a pre-determined time has elapsed since attempting the change in access mode; and
reverting to a previous access mode or an alternative changed access mode, in response to determining that the pre-determined time has elapsed.

50. The method of claim 41, wherein the instruction is received from a network to which the UE is connected.

51. The method of claim 41, wherein receiving an instruction or detecting a trigger comprises determining that one or more pre-determined conditions for changing access mode have occurred.

52. The method of claim 41, wherein receiving an instruction or detecting a trigger comprises receiving an instruction to change access mode from a network to which the UE is connected.

53. A method performed by a network node, the method comprising:
receiving, from a user equipment, a message comprising an indication of an out-of-coverage (OoC) situation encountered by the user equipment in connection with an attempted change in access mode and/or information and/or measurements pertaining to the OoC situation, wherein the change in the UE's access mode includes a change in one or more radio resources available to the UE for accessing a network.

54. The method of claim 53, further comprising, prior to said receiving, receiving an indication from the user equipment that the message is available and, responsive to the indication that the message is available, sending a request to the user equipment for the message.

55. The method of claim 53, wherein the network node belongs to a different communication network than a communication network to which the OC situation relates and wherein the method further comprises forwarding the message to the communication network to which the OoC situation relates.

56. The method of claim 53, further comprising, based on the message, adapting a configuration of a communication network to which the OoC situation relates.

57. A user equipment (UE) comprising radio circuitry for communicating with a network and processing circuitry operatively coupled to the radio circuitry and configured to:
receive an instruction or detect a trigger to change the UE's access mode, wherein the change in the UE's access mode includes a change in one or more radio resources available to the UE for accessing a network;
determine that the UE has experienced an out-of-coverage (OoC) situation with respect to the change in the UE's access mode; and
log, for subsequent reporting, an indication of the OoC situation and/or information and/or measurements pertaining to the OoC situation.

58. The UE of claim 57, wherein the processing circuitry is further configured to:
connect to a network, subsequently to said logging; and
report the logged indication and/or measurements and/or information to the network.

59. A network node comprising radio circuitry configured to communicate with one or more user equipments (UEs) and processing circuitry operatively coupled to the radio circuitry and configured to:
receive, from a user equipment, a message comprising an indication of an out-of-coverage (OoC) situation encountered by the user equipment in connection with an attempted change in access mode and/or information and/or measurements pertaining to the OoC situation, wherein the change in the UE's access mode includes a change in one or more radio resources available to the UE for accessing a network.

60. The network node of claim 59, wherein the processing circuitry is further configured to, prior to said receiving, receive an indication from the user equipment that the message is available and, responsive to the indication that the message is available, send a request to the user equipment for the message.
